(19) United States
(12) Patent Application Publication
(10) Pub. No.: US 2019/0273417 A1
(43) Pub. Date: Sep. 5, 2019

(54) MAGNETIC MOTOR

(71) Applicant: Volontimir SENIK, Ierissos (GR)

(72) Inventor: Volontimir SENIK, Ierissos (GR)

(21) Appl. No.: 15/927,439

(22) Filed: Mar. 21, 2018

(30) Foreign Application Priority Data
Mar. 2, 2018 (DE) 202018101166.9

(51) Int. Cl. H02K 7/075; H02K 33/16

(52) U.S. Cl. CPC H02K 7/075; H02K 53/00; H02K 33/16

(57) ABSTRACT

Usage: for the potential energy conversion of permanent magnets into the mechanical ones and with subsequent its conversion to the other types of energy, for example, paired with an electric generator to generate the electrical energy. The technical result consists in the conversion the potential energy of permanent magnets into the mechanical one. The motor contains a body, made of non-magnetic material, a rotor and a stator magnet-slide platen, movable in the radial direction to the rotor, mounted on guides, with a possibility of reciprocating movement and by means of the connecting rod connected to the rotor, the design is a slider-crank mechanism. The rotor-cylinder with the magnets is arranged in a special order on its lateral surface. The rotor is attached to the power take-off shaft. The magnet-slide platen, by means of the reciprocating motion transformer into the rotational movement, drives the rotor into the rotational movement.

### CROSS-REFERENCE TO RELATED APPLICATIONS

The present patent application claims priority to German application No. DE 202018101166.9 filed on Mar. 2, 2018.

### FIELD OF INVENTION

The invention relates to the power engineering field, in particular the building of motors, and can find an application in various fields of industry and in everyday routine.

### BACKGROUND

The purpose of the present invention is to create a practical magnetic motor using the phenomena of the attraction of unlike and the repulsion of the analogous poles of permanent magnets, which are repeating alternately and continuously with the attractive and repulsive forces transformation to the torque of the power take-off shaft, and the accumulated kinetic energy into mechanical one for the useful work performing. As a result of the proposed invention using, it becomes possible to convert the potential energy of permanent magnets into a mechanical one.

The closest in technical essence to the proposed solution is the magnetic motor of the Russian inventor A. A. Kalinin (patent for the utility model of the Russian Federation No. 34826). The motor consists of a body, a stator and the rotary permanent magnets facing the analogous poles, between which a magnetic screen is inserted. The reciprocating motion of the rotor magnet, which is fixed on the connecting rod c by means of the main circulation system, is converted into the power take-off shaft rotational motion. Disadvantages of this design are: the inability to increase the amount of the removed kinetic energy, large energy losses during the magnetic screen input and output, a small torque that is formed only on the main circulation system half speed.

### SUMMARY

The magnetic motor proposed design, in comparison with the mentioned, has a number of important advantages, namely, the possibility of removing any amount of kinetic energy by increasing the rotor diameter, with fixed losses on the critical arc. For any of the rotor diameter, the critical arc length remains unchanged. The motor arrangement allows the rotor concentrically place any number of stator magnet slide platens with radial beams at equal angles both on the outer side and on the inside of the rotor, which significantly increases the motor efficiency. The design made with the arrangement of the guides with the magnets-slide platens inside the hollow rotor and the rotor magnets placement along the rotor inner surface will be more compact. The rotor rotation with reference to the stator takes place without the moments exchange, according to the principle of a magnetic bearing, in what connection the torque, with the exception of the angle, which corresponds to the critical arc length, is generated for the main circulation system entire complete revolution, which ensures the conversion high percentage of the permanent magnets potential energy to the kinetic energy of the rotor rotation. The more efficient usage of the reciprocating motion converters into the rotary one instead of the main circulation system, also increases the efficiency of the motor. The usage of the arc-shaped rotor and stator magnets with the poles, arranged in the same plane, allows using the permanent magnets energy potential more fully. The usage of an electromagnet, fixed in the slide platen casing, commutated in such a way that during the passage of the critical arc, the electromagnet should be disconnected from the direct current source instead of the stator electromagnet, what minimizes the energy losses during the passage of the critical arc and turns this construction into an efficient electric motor.

The above-mentioned technical result is achieved by the fact that the permanent magnet motor comprises a body 1 of the non-magnetic and preferably non-metallic material in which, on the bearings 13, the power take-off shaft 12 rotates with a cylindrical rotor 7 fixed on it, containing permanent magnets 10 and 11 on the lateral faces. Throughout the CAO arc of the of the rotor 7 lateral surface, the permanent magnets 10 are arranged with the N-pole to the stator magnet 4. Throughout the CBO arc of the of the rotor 7 lateral surface, the permanent magnets 11 are arranged with the S-pole to the stator magnet 4. Through the arc AO, the rotor magnets 10 and along the arc BO rotor the magnets 11 are assembled in the form of wedges, converging at the point O. On the straight line CO, passing through the center of the rotor 7 circle, the crank stud 8 is placed, which is connected through the connecting-rod bearing 9 to the connecting rod 6. Since the rotor 7 also serves as a flywheel, it is manufactured from the non-magnetic material, for example, bronze, can be manufactured with the lead inserts for the mass increasing.

Inside the body 1 the guides 2 are fixed, which made, for example, of brass, in the form of rods on which a slide platen 3 is mounted, and which is manufactured from a non-magnetic material, for example Teflon, with the permanent cylindrical magnet 4 of the axial volume density of magnetic pole strength, directed by the S-pole to the rotor 7. The slide platen 3 comprises a crank pin 5 with which by means of an aluminum crank rod 6, a connection between the slide platen 3 and the crank pin 8 is performed. The number of stator magnet-slide platens 3 can be any, and is limited only by the geometric dimensions of the rotor 7, in which case they are located on the guides 2, arranged concentrically to the rotor 7 at the same distance from each other, and the crank rods 6, and connected to the crank pins 8. All the rotating elements of this motor are made on ball bearings 9 and 13 of the closed type, which carries out the motor lubrication. The mechanism is covered with a cover 14, made of the non-magnetic material.

### BRIEF DESCRIPTION OF THE DRAWINGS

The essence of the invention is illustrated in FIG. 1, 2, 3, 4, 5.

FIG. 1 shows the general scheme of the motor longitudinal section, rear view.

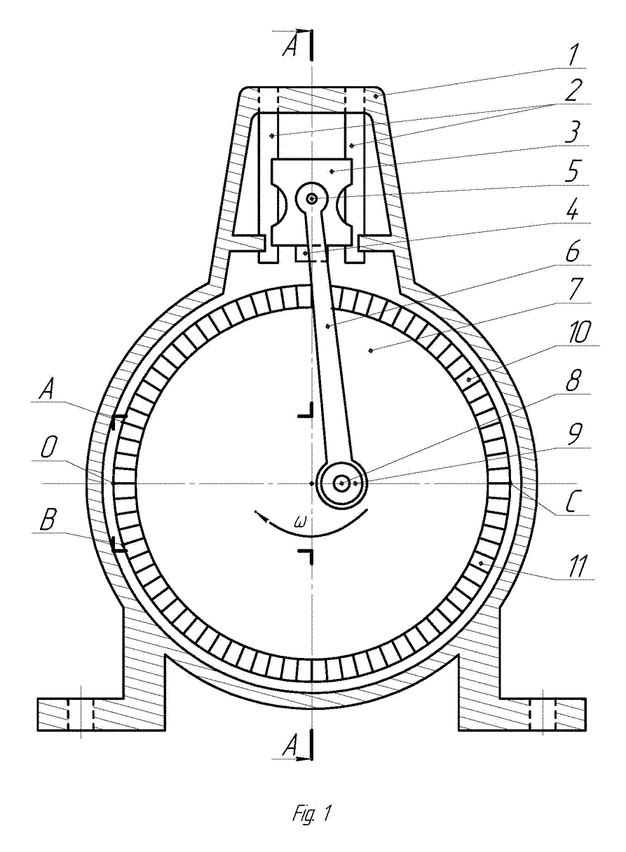

FIG. 2 shows the general scheme of the motor in longitudinal section, side view.

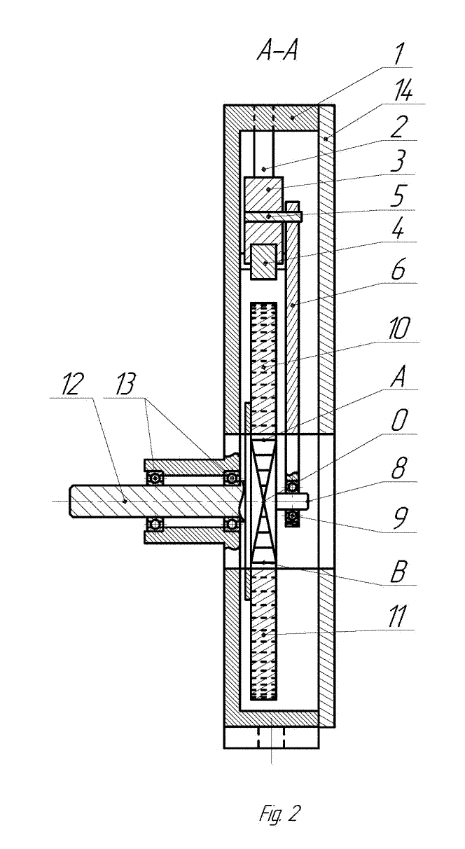

FIG. 3 shows the diagram of a motor mechanism with one stator magnet-slide platen.

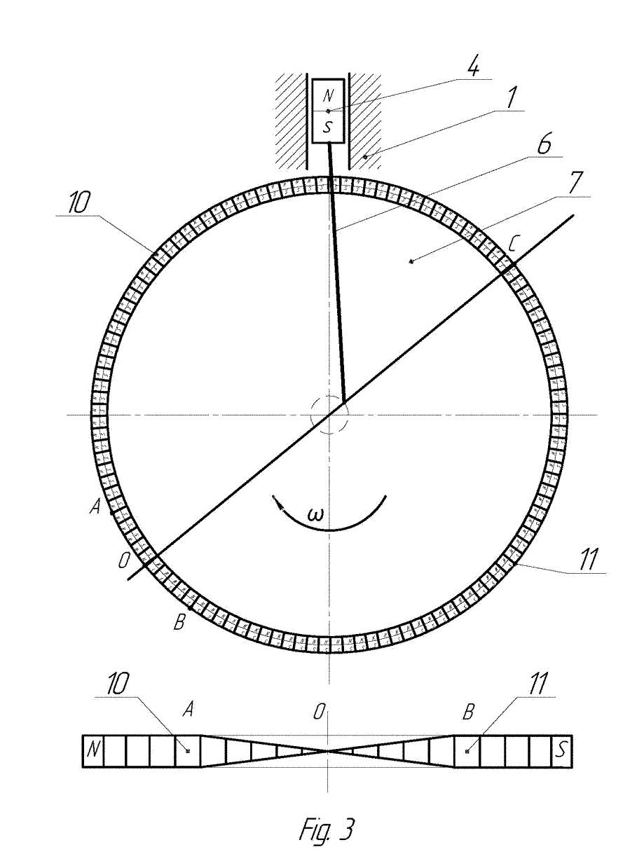

FIG. 4 shows the diagram of a motor mechanism with six stator magnet-slide platens.

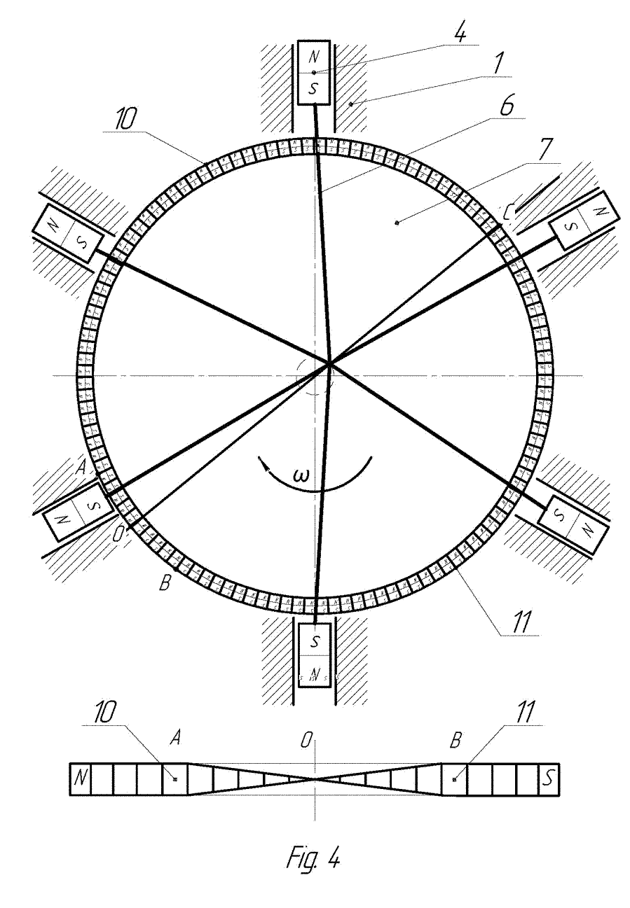

FIG. 5 shows the diagram of the motor mechanism with six stator magnet-slide platens located inside the rotor.

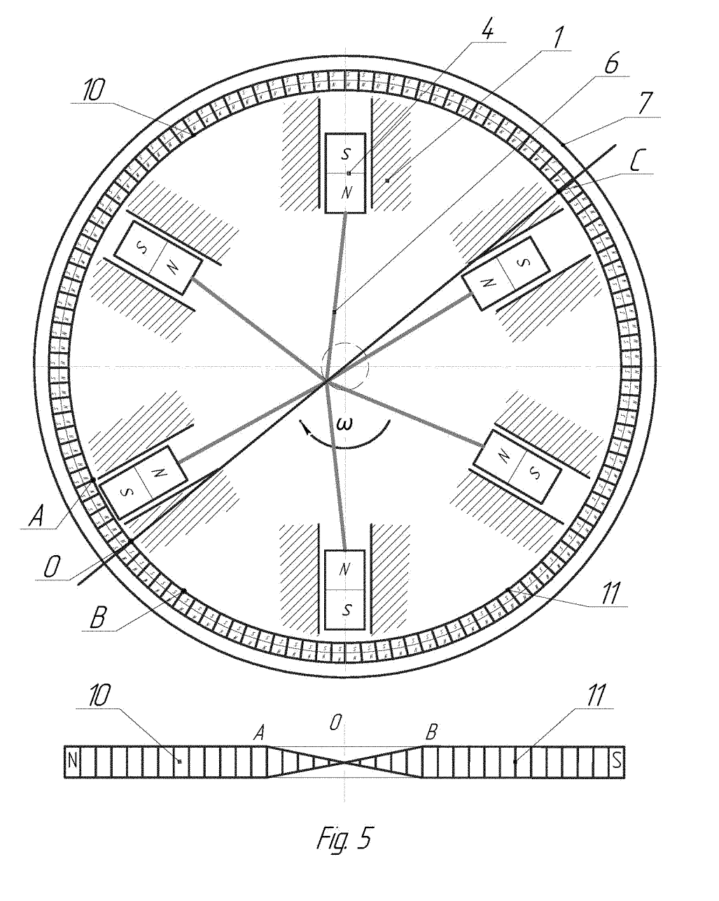

### DETAILED DESCRIPTION OF THE PREFERRED EMBODIMENT

The motor on the permanent magnets works as follows. Starting from the point B on the side surface of the rotor 7, the rotor magnets 11 mutual repulsion, arranged by the S-pole along the entire length of the arc of the OBC and the stator magnet 4, also located with the S-pole to the rotor 7, pushes the stator magnet-slide platen 3 in the direction from the rotor to the upper dead center (UDC). Moving towards the UDC, the magnet-slide platen 3, by means of the main circulation system, rotates the rotor 7. With respect to the temporarily non-rotatable stator magnet-slide platen 3, that reaches the UDC at the point C on the rotor lateral surface, the torque appears that coincides with the initial and attached torque to the surface of the rotor. Further, as a result of the opposite poles mutual attraction, S of the stator magnet 4 and N poles of the rotor magnets 10, there is the force is generated, which entrains the stator magnet-slide platen 3 towards the rotor 7, to the bottom dead center (BDC). Moving towards the BDC, the magnet-slide platen 3, by means of the main circulation system, continues to accelerate the rotor 7 in the same direction. Over the arc AO length of the rotor 7 side surface, due to the wedge shaped assembly of the rotor magnets 10, the rotor 7 gently exits from the interworking with the stator magnet 4. After passing by inertia through the point O, the rotor 7, thanks to the wedge shaped assembly of the rotor magnets 11 throughout the arc OB, gently enters in the interworking with the stator magnet 4. A part of the accumulated kinetic energy is lost to overcome the critical arc AOB. Having reached the point B on the lateral surface of the rotor 7, the rotor 7 enters the working area and the cycle repeats.

The description of a preferred embodiment of the invention has been presented for purposes of illustration and description. It is not intended to be exhaustive or to limit the invention to the precise forms disclosed. Obviously, many modifications and variations will be apparent to practitioners skilled in this art. It is intended that the scope of the invention be defined by the following claims and their equivalents.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What we claim is:

1. A magnetic motor, comprising: a body of a non-magnetic material in which a power-takeoff is installed on cartridge type bearings, characterized in that a cylindrical rotor of the non-magnetic material is mounted on a power take-off shaft, with permanent magnets placed on its side surface that are arched, which are densely adjusted to each other, with a radial volume density of magnetic pole strength and a same force of cohesion, which along a half of a lateral surface of the rotor are oriented by a S-pole outward, and in a second half—by a N-pole, an interworking of which with a stator magnet-slide platen, in a shuttle-like manner moving along guides, fixed in the body by a means of a shuttle-like manner motion transformer into a rotational movement, drives the rotor into the rotational movement.

2. The magnetic motor of claim 1, characterized in that a width of a rotor magnet is equal to or less than a width of a stator magnet, and its length is equal to or greater than a length of the stator magnet.

3. The magnetic motor of claim 1, characterized in that on certain critical areas, in an exit and an entry areas of a working zone, the rotor magnets are assembled in a form of wedges, with peaks occurring on a poles boundary.

4. The magnetic motor of claim 1, characterized in that within the body, concentrically to the rotor, with radial beams, through equal angles, slide platens, made from the nonmagnetic material, including Teflon, are placed, with the permanent magnets of an axial volume density of magnetic pole strength, fixed in them, which are facing with one pole to rotor magnets, and which are performing a reciprocating motion in a direction, which is radial to the rotor, along the guides, made of the non-magnetic material, including brass, and which, by means of the of the shuttle-like manner motion transformer into the rotational movement, drives the rotor into the rotational movement.

5. The magnetic motor of claim 1, characterized in that the stator magnet-slide platens with the guides, which are placed concentrically to the rotor, with radial rays through equal angles inside the hollow rotor, and the rotor magnets are located along the rotor inner surface.

6. The magnetic motor of claim 1, characterized in that arched with poles, located in one plane, the rotor and similar stator permanent magnets are faced by both of their poles counter-currently.

7. The magnetic motor of claim 1, characterized in that instead of the permanent stator magnet, an electromagnet is used, which is fixed in a slide platen casing, and fed from a constant current source, with an interruption of a current supply when a critical arc passing on the rotor surface.

8. The magnetic motor of claim 1, characterized in that as the transformer of the reciprocating motion into a rotary one, a main circulation system with a connecting rod, made of the non-magnetic material, including aluminum, is used, in a neck of which the cartridge type bearing is contained, by means of which a contact of a connecting rod with a crank is carries out, and in a multi-stator version of the motor, depending on the number of the stators, the connecting rod with the bearing is a main one, and others are the motor-drawn ones and fixed to the main connecting rod in its circumferential direction, or all connecting rods are the motor-drawn ones and attached to a periphery of a plain washer with the bearing.

9. The magnetic motor of claim 1, characterized in that the guides and the slide platen are made of the non-magnetic material with a low coefficient of friction or with a use of an anti-friction bearing.

10. The magnetic motor of claim 1, characterized in that the motor body is made of solid plastics.
